(19) United States
(12) Patent Application Publication
(10) Pub. No.: US 2025/0045344 A1
(43) Pub. Date: Feb. 6, 2025

(54) METHOD TO RECOVER COMPRESSED TELEMETRY DATA

(71) Applicant: Dell Products L.P., Round Rock, TX (US)

(72) Inventors: Benjamin P. Fauber, Austin, TX (US); William Porteous, Austin, TX (US); Rachel A. Ward, Bellevue, WA (US)

(21) Appl. No.: 18/365,573

(22) Filed: Aug. 4, 2023

(51) Int. Cl. G06F 17/11

(52) U.S. Cl. CPC G06F 17/11

(57) ABSTRACT

Recovery of telemetry signals or data is disclosed. Telemetry data is compressed to generate compressed data by applying a matrix to original data. The exact original data or an estimate of the original data is recovered by generating an optimization problem. The solution to the optimization problem is an estimate of the original data. The recovered data can be used to perform various operations as if it were the original data even if there is some loss in the recovered data.

### RELATED APPLICATIONS

This application is related to U.S. Ser. No. 17/675,848 filed Feb. 18, 2022, and entitled COMPRESSION OF TELEMETRY SENSOR DATA WITH LINEAR MAPPINGS, which application is incorporated by reference (hereinafter Compression of Telemetry Sensor Data).

### FIELD OF THE INVENTION

Embodiments of the present invention generally relate to compressing and decompressing data. More particularly, at least some embodiments of the invention relate to systems, hardware, software, computer-readable media, and methods for recovering compressed data, such as compressed telemetry data.

### BACKGROUND

Computing systems, applications and devices (e.g., sensors) often generate/transmit/store data such as logs and telemetry data. This data may be used for various purposes, such as performing various types of research, customer service, or the like. For example, high-frequency telemetry data is often instrumental in detecting hardware anomalies and in proactively supporting customers. This type of data can be mined for various purposes and may prove useful to various users including data scientists.

However, storing this type of data can consume a lot of storage. To conserve or manage storage requirements, this type of data is often compressed prior to being stored. Compressing the data, however, is not without cost. The compression may be lossy. Thus, when the compressed data is retrieved for use and decompressed, the decompressed data may be different from the original data. Further, decompressing data can require substantial compute time and may be difficult to perform.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a computing system including a telemetry server configured to store data such as logs and telemetry data;

FIG. 2 discloses aspects of compressing telemetry data;

FIG. 3 discloses aspects of reconstructing compressed telemetry data;

FIG. 4 discloses aspects of a recovery or reconstruction operation for compressed data; and

FIG. 5 discloses aspects of a computing device, system, or entity.

### DETAILED DESCRIPTION OF SOME EXAMPLE EMBODIMENTS

Embodiments of the present invention generally relate to compressing and decompressing data. More particularly, at least some embodiments of the invention relate to systems, hardware, software, computer-readable media, and methods for recovering (e.g., reconstructing, decompressing) compressed data such as telemetry data. Telemetry data may include, by way of example, univariate/multivariate time series data, sampled signal data, or the like. Telemetry data may include signals and/or signals that are converted to digital form (e.g., vectors).

Embodiments of the invention relate to recovering data from compressed data. Embodiments of the invention are configured to recover the compressed data sufficiently such that operations and outcomes (e.g., data science operations, customer service) performed on the recovered data are nearly identical to the same operations and outcomes performed on the original data.

For example, embodiments of the invention may recover data from compressed data with a root mean squared error (RMSE) of about 3% (or less) at 6-fold compression and about 12% or less at 11-fold compression when comparing normalized original data to the normalized recovered data. Further, embodiments of the invention can apply to irregular time series data and to time series data of any dimension.

Recovering estimated data from the compressed data may be used to validate data science solutions created using only the compressed data, root cause analysis, and supporting tools that may require original data. Original signals or estimates of original signals can be generated from recovered data.

By way of example only, telemetry data is often batched or bundled into timestamped metric readings, which are then bundled into JSON (Javascript Object Notation) documents. There are typically ˜20 pre-defined JSON documents that are sent at a larger interval. Typical telemetry data delivery intervals can be as short as every minute (for data that was collected every 1-5 seconds and transferred internally from internal data centers) to as infrequent as every 3 weeks.

Data collectors (e.g., on-premise data collectors) receive telemetry data from different devices, hardware, computers, sensors, or the like. The disparate telemetry data may be grouped together and transmitted to a central database. At the central database, the grouped data are processed, and the individual timestamped metric values may be ingested into a tabular database along with relevant metadata like source identifier and metric instance info and metric group where possible.

Compression of high-frequency telemetry data to a smaller package for transmission and storage for later use in anomaly detection and data science application is appealing. Further, the ability to execute data science applications on the compressed data to achieve nearly identical results to the full-length telemetry signal is very valuable. Embodiments of the invention relate to recovering the original signal (or an estimate thereof) from the compressed signal.

Recovering the telemetry data from the compressed telemetry data can be described using an ‘inverse problem’ framework. The original uncompressed data may be expressed as a vector xᵢₙ or x. A specific linear map A (matrix) is applied to the vector and compressed data is generated. The compressed data is a lower dimensional vector bₒᵤₜ. This relationship is expressed as follows: bₒᵤₜ=Axᵢₙ. This may be generalized herein as y=Ax.

Recovering data from the compressed data may be initiated with the compressed data bₒᵤₜ. In one example, the original data is recovered by solving a linear inverse problem. Embodiments of the invention relate to decompressing the data or to solving the inverse problem. To determine xᵢₙ, a mathematical characterization of the signal vector that is computable is sought. In this context, xᵢₙ is represented as the unique vector which solves an associated convex optimization problem which takes bₒᵤₜ as an input.

Embodiments of the invention thus relate to recovering full length data (or signal) from compressed data (or signal). The recovered data represents the same information that was in the original data. In one example, the error between the recovered data and the original data may be controlled. Embodiments of the invention can be applied to integer and float time series data of any duration and frequency. Embodiments of the invention further allow the quality of the recovered data to be controlled. The relationships between signal recovery quality, initial signal compression ratio, and signal complexity allow the recovery process to account for these variables.

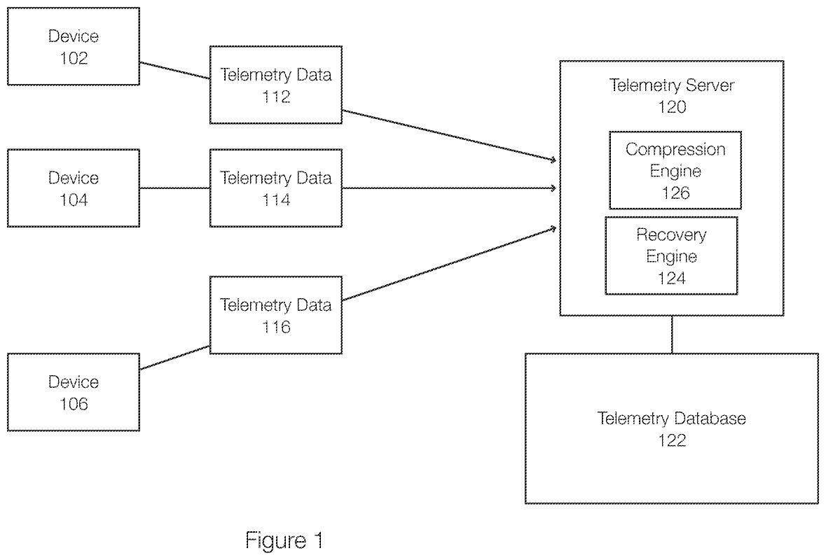

FIG. 1 discloses aspects of an example environment or system in which data such as telemetry data may be recovered. FIG. 1 illustrates a telemetry server 120 that includes a recovery engine 124 and that includes or is associated with a telemetry database 122, which may be stored in storage devices. The telemetry server 120 may be an on-premise server/system, an edge based server/system, a cloud based server/system, a cluster of servers and may include processors, memory, networking hardware and the like.

The recovery engine 124 may be configured to perform recovery operations that may include, by way of example, decompression operations, inverse operations, matrix operations, or the like. The recovery engine 124, in one example, is configured to recover data from compressed data or, more specifically in one example, recover telemetry data from compressed telemetry data.

The telemetry server 120 may be configured to receive telemetry data 112, 114, and 116 from, respectively, devices 102, 104, and 106. The device 102, 104, and 106 are representative of devices that collect, measure, and/or generate telemetry data. In another example, the telemetry data 112, 114, and 116 is representative of device operations. The telemetry data 112, 14, and 116 may be time series data. Further, embodiments are discussed in the context of data and time series data, but the telemetry data may also represent continuous signals, samples of continuous signals or other data types.

For example, if the device 102 is a smart disk drive or a storage device (the type of device may determine the specific telemetry data), the telemetry data 112 may include, by way of example and not limitation, data about multiple metrics of the device such as error count, command timeout, drive temperature, write count, read count, cycle count, power on, error rate, reallocated block count, unused block count, reads, writes, or the like or combination thereof. Analyzing the telemetry data associated with disk drives can be used to predict drive failure, identify performance issues, and the like.

The telemetry server 120 may also include a compression engine 126 that may be configured to compress the telemetry data 112, 114, and 116 and store the compressed telemetry data in the telemetry database. The telemetry data may be compressed prior to transmission to the telemetry server 120. The telemetry data may be compressed as described in U.S. Ser. No. 17/675,848 filed Feb. 18, 2022, and entitled COMPRESSION OF TELEMETRY SENSOR DATA WITH LINEAR MAPPINGS, which application is incorporated by reference (hereinafter Compression of Telemetry Sensor Data).

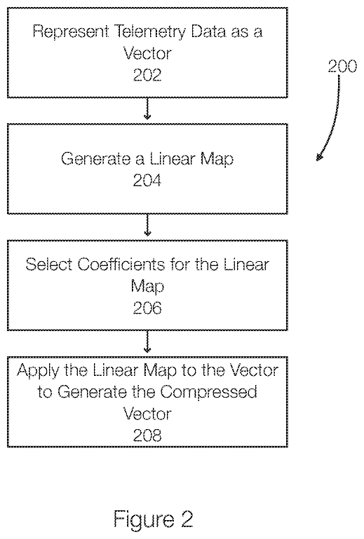

FIG. 2 discloses aspects of compressing data such as telemetry data. In the method 200, telemetry data is represented 202 as a vector. More specifically, the telemetry data is represented as a vector of values xᵢₙ∈ [symbol] ^{d}, where d is a dimension of the vector. Next, a linear map is generated 204. Generating the map may include selecting 206 coefficients for the linear map. The linear map is then applied 208 to the vector to generate the compressed vector.

More specifically, a matrix A∈ [symbol] ^{m×d} is applied to the vector xᵢₙ. The coefficients of the matrix A are sampled from a Gaussian distribution of N(0,1) or

$$N ( 0 , \frac{1}{m} ) ,$$

where m<<d. More specifically, Aᵢⱼ˜ [symbol] (0,1) or

$$𝒩 ( 0 , \frac{1}{m} ) .$$

In some example embodiments, A is not square and is not symmetric or positive definite.

Applying the matrix to the input vector generates a lower-dimensional (e.g., shorter) vector bₒᵤₜ∈ [symbol] ^{m}, which is the compressed vector in one example. Thus:

$${b}_{out} = A * {x}_{i n} or y = A * x$$

In a recovery operation, embodiments of the invention recover a signal x̅ that produced a compressed signal y or bₒᵤₜ. Linear algebra suggests that there any many different (infinite) signals that satisfy A(x̅)=y and at least d−m linearly independent families of such signals. Recovering the exact signal x in this setting is thus an ill-posed problem and embodiments of the invention overcome this ill-posed problem.

Many telemetry signals or data x are gradient sparse, which suggests that the numbers of non-zero changes in the signal is much smaller than the number of total signal positions (d). More precisely, if Dx=(xᵢ₊₁−xᵢ)∈ [symbol] ^{d-1} is the gradient of the signal (e.g., the vector of its differences), then the sparsity, k, of Dx is a count of its number of non-zero entries. Thus, k=∥Dx∥ₗ_{⁰}=|{Dxⁱ:Dxⁱ≠0}|.

J. F. Cai, W. Xu, Guarantees of Total Variation Minimization for Signal Recovery, arXiv preprint arXiv: 1301.6791 (2013) and F. Krahmer and R. Ward, ‘New and improved Johnson-Lindenstrauss embeddings via the Restricted Isometry Property.’ SIAM J. Math. Anal. 2011, 43 (3), 1269-1281, which are incorporated by reference in their entirety, generally support the concept that if a signal is gradient sparse, the linear inverse problem can be solved.

When the original signal x is gradient sparse (i.e., (k<<d)), the exact signal x corresponding to the compressed signal y can be recovered. Further, a vector \hat{x} that is very close to x̅ can be recovered. In embodiments of the invention, the vector \hat{x} has a known error and can be controlled. Thus, when A is exactly a Gaussian projection matrix, then Guarantees of Total Variation Minimization for Signal Recovery gives results on how to recover input vectors x from their Gaussian measurements provided that the signals x are one-dimensional and are gradient-sparse or approximately gradient sparse.

More specifically, suppose that A∈ [symbol] ^{m×d} has independent entries sampled from a standard normal distribution ( [symbol] (0,1)) and that the Gaussian measurement y∈ [symbol] ^{m} of some original vector (signal) x̅∈ [symbol] ^{d} and that y=Ax̅.

If constants c₁, . . . , c₄ exist so that if m and k=∥Dx̅∥ₗ_{⁰} satisfy the relationship

$$m \geq {c}_{3} \sqrt{d k} log ( d ) + {c}_{4} ,$$

then the vector x̅ can be found as a unique solution to the optimization problem

$$\begin{matrix}{minimize}_{x ∈ {ℝ}^{d}} {‖ Dx ‖}_{1} , \\ subject to Ax = y ,\end{matrix}$$

with probability 1−c₁ exp(−c₂\sqrt{m}).

In addition, the bounds can be improved in some instances. For example,

$$m \geq {c}_{3} k log ( d )$$

Is possible if x is exactly k gradient-sparse.

This suggests that if m is sufficiently large then the vector x can be recovered from the data y (the compressed data) provided that x̅ had a sufficiently sparse gradient. This may be extended to approximately sparse gradients and to noisy data.

In one example, the input data y is at most & noise away from the projection of a signal: y=Ax̅+w, where ∥w∥₂<ε. Further, it may be assumed that x is not perfectly gradient sparse. Rather, the error of the best k-sparse approximation to x is given by

$${e}_{k} = {min}_{\vert 𝒦 \vert \leq k} {‖ D {\overline{x}}_{{𝒦}^{c}} ‖}_{1} = {‖ D \overline{x} - D {\overline{x}}_{{𝒦}_{0}} ‖}_{1} .$$

In other words, Dx̅ [symbol] _{₀} is a vector which is zero except at the k indices of [symbol] ₀ where Dx̅ is biggest (i.e., the best k-sparse approximation to the gradient Dx̅). Then, eₖ is the l₁ error of this approximation.

Next, suppose that y is close to being the Gaussian measurement y−Ax̅+w where ∥w∥₂<ε and that m<d. In this example, there exists a sparsity level k and constants c₁, . . . , c₃ such that if \hat{x} is the solution to the optimization

$$\begin{matrix}{minimize}_{x ∈ {ℝ}^{d}} {‖ Dx ‖}_{1} \\ subject to ‖ Ax - y ‖ \leq ε\end{matrix}$$

with probability

$$1 - {c}_{0} exp ( - {c}_{1} \sqrt{m} ) ,$$

$$then$$

$${‖ \hat{x} - \overline{x} ‖}_{2} \leq {c}_{2} \frac{{e}_{k}}{\sqrt{d}} + {c}_{3} \frac{ε}{\sqrt{d}} .$$

This suggests that even if a signal x is not exactly gradient sparse, the signal x can be approximated by taking the solution x to the optimization problem minimiz [symbol] ∥Dx∥₁. This further suggests that the l₂ error between x and x is controlled by both the error in yε and eₖ.

The results of Cai and Xu in Guarantees of Total Variation Minimization for Signal Recovery required that the projection matrix A be exactly a Gaussian. These results have not been shown to apply to compressed vectors y generated via SRHT (Subsampled Randomized Hadamard Transform). Embodiments of the invention thus apply to SRHT generated compressed vectors and/or to matrices satisfying a restricted isometry property.

Embodiments of the invention thus recover a signal x̅∈ [symbol] ^{d} by acquiring the solution \hat{x} to:

$$\begin{matrix}{minimize}_{x ∈ {ℝ}^{d}} {‖ Dx ‖}_{1} \\ subject to Ax = y\end{matrix}$$

$$or to$$

$$\begin{matrix}{minimize}_{x ∈ {ℝ}^{d}} {‖ Dx ‖}_{1} \\ subject to ‖ Ax - y ‖ \leq ε .\end{matrix}$$

This is achieved, in one example, by implemented an alternating direction method of multipliers (ADMM). To solve the problem

$$\begin{matrix}{minimize}_{x ∈ {ℝ}^{d}} {‖ Dx ‖}_{1} \\ subject to ‖ Ax - y ‖ \leq ε\end{matrix}$$

using ADMM, the problem may be generalized as a LASSO problem (see Boyd et. Al. in Distributed Optimization and Statistical Learning via the Alternating Direction Method of Multipliers (2010), which is incorporated by reference.

This is represented as

$$minim {ize}_{x ∈ {ℝ}^{d}} \frac{1}{2} {‖ Ax - b ‖}_{2} + λ {‖ Dx ‖}_{1} , λ > 0.$$

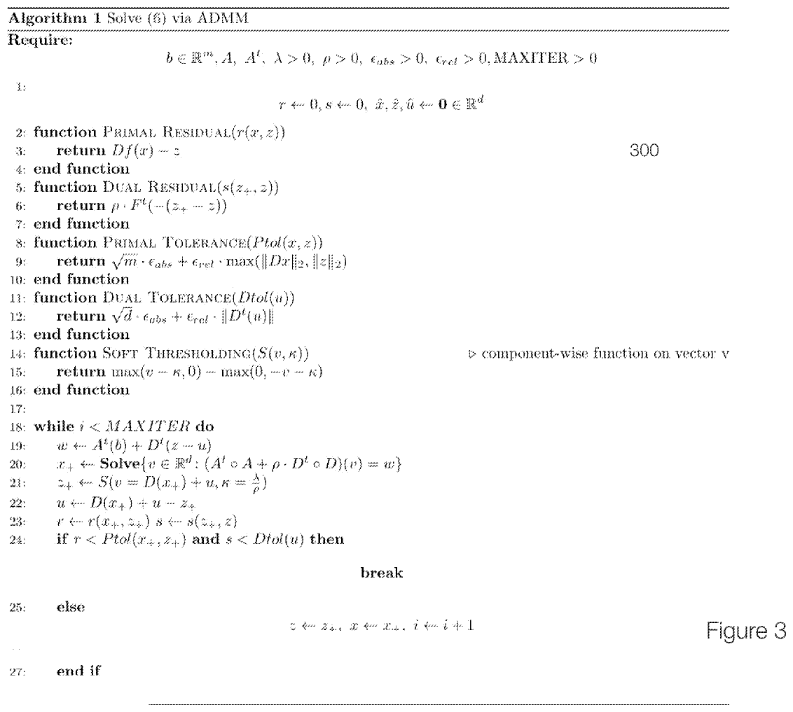

To understand this as a generalized LASSO, x→Dx∈ [symbol] ^{d-1} can be understood as applying a specific matrix D with values of {1,−1,0} to the vector x. The ADMM algorithm to solve this problem is illustrated in FIG. 3. FIG. 3 thus illustrates an example 300 of applying ADMM to solve for x.

In an example of the ADMM algorithm, the parameters include λ and ρ for minimization and εₑₚₛ and εᵣₑₗ for stopping criteria. In one example, λ may be chosen via cross-validation. In on example,

$$minim {ize}_{x ∈ {ℝ}^{d}} \frac{1}{2} {‖ Ax - b ‖}_{2} + λ {‖ Dx ‖}_{1} ≡ {minimize}_{x ∈ {ℝ}^{d}} λ ( \frac{1}{2 λ} {‖ Ax - b ‖}_{2} + {‖ Dx ‖}_{1} ) ≡ {minimize}_{x ∈ {ℝ}^{d}} ( \frac{1}{2 λ} {‖ Ax - b ‖}_{2} + {‖ Dx ‖}_{1} ) .$$

Taking λ to be small corresponds to a greater penalty on the error ∥Ax−b∥₂. In one example, for testing, the values used were: εᵣₑₗ=1e−4, ε_{abs}=1e−4, λ=1e−3, and ρ=1. This setting gave an error of 12 percent RMSE on a set of iDRAC data with d=6k and m=512, with a MAXITER of 5k.

As described herein, the linear inverse problem often fails because the compression matrix A fails to satisfy certain requirements such as symmetry and positive definiteness. Embodiments of the invention overcome and allow a solution or an estimated solution to be determined even when the matrix A does not have symmetry or positive definiteness.

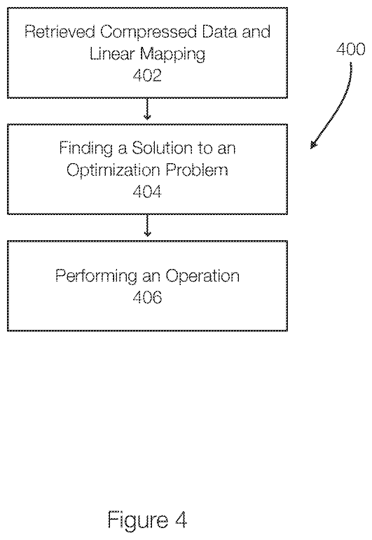

FIG. 4 discloses aspects of a recovery operation. A recovery operation to recover the original matrix from the compressed matrix may begin by obtaining a compressed matrix, such as bₒᵤₜ or y.

The method 400 can be summarized as follows. First, it is assumed that y (or xᵢₙ)=(xⁱ) denotes a signal or compressed data and Dxᵢₙ=(xⁱ⁺¹−xⁱ) denotes its gradient. Further, [symbol] is a number of nonzero entries in Dxᵢₙ and the compression matrix A is available. The length of xᵢₙ is denoted as [symbol] and the length of y (or bₒᵤₜ) is denoted as M.

If [symbol] and M satisfy the following relationship:

$$M \geq \sqrt{𝒩 \cdot 𝒦} ( {c}_{1} log 𝒩 + {c}_{2} ) ,$$

then xᵢₙ can be recovered from y (or bₒᵤₜ) by solving the following convex optimization problem:

$$( M ) minimize {‖ {D}_{x} ‖}_{1} , subject to Ax = y ( or {b}_{out} ) .$$

M can be solved using the ADMM algorithm. The values of c₁ and c₂ are shown for completeness, but they do not affect the overall bounds of solving M. When performing the ADMM, more iterations may reduce the error in the output.

FIG. 4 illustrates an example embodiments of recovering data. The method 400 includes retrieving 402 compressed data and a linear mapping. The compressed data may be retrieved from storage or obtained in a different manner.

Next, a solution to an optimization problem is determined 404. The optimization problem includes minimizing a gradient subject to the original compression. In one example, this is achieved by performing an ADMM algorithm. Once the solution is obtained, an operation 406 may be performed in various practical applications. Example operations include data science operations, identifying a root cause, providing customer service, or the like.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, recovery operations, decompression operations, matrix operations, inverse linear operations, data science operations, customer service operations, or the like. More generally, the scope of the invention embraces any operating environment in which the disclosed concepts may be useful.

Example cloud computing environments, which may or may not be public, include storage environments that may provide data protection functionality for one or more clients. Another example of a cloud computing environment is one in which processing, data protection, and other services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, storage system components such as databases, storage servers, storage volumes (LUNs), storage disks, and other memory, for example, may likewise take the form of software, physical machines or virtual machines (VMs), though no particular component implementation is required for any embodiment.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

It is noted that any operation(s) of any of these methods may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.
Embodiment 1. A method comprising: obtaining a compressed data and a linear mapping, wherein the compressed data is generated from original data, creating an optimization problem using the compressed data and the linear mapping, solving the optimization problem to generate a solution, wherein the solution corresponds to the original data, and performing an operation using the solution.
Embodiment 2. The method of embodiment 1, wherein the original data comprises telemetry data.
Embodiment 3. The method of embodiment 1 and/or 2, wherein the linear mapping comprises a Gaussian matrix and wherein coefficients are sampled from a Gaussian distribution.
Embodiment 4. The method of embodiment 1, 2, and/or 3, wherein the solution is an estimated solution.
Embodiment 5. The method of embodiment 1, 2, 3, and/or 4, further comprising selecting parameters for minimization and for stopping criteria.
Embodiment 6. The method of embodiment 1, 2, 3, 4, and/or 5, further comprising controlling an error of the solution.
Embodiment 7. The method of embodiment 1, 2, 3, 4, 5, and/or 6, further comprising solving the optimization problem using an alternating direction method of multipliers.
Embodiment 8. The method of embodiment 1, 2, 3, 4, 5, 6, and/or 7, further comprising performing at least one of a data science operation, a customer service operations, or a root cause analysis operation.
Embodiment 9. The method of embodiment 1, 2, 3, 4, 5, 6, 7, and/or 8, wherein the original data is not exactly gradient sparse.
Embodiment 10. The method of embodiment 1, 2, 3, 4, 5, 6, 7, 8, and/or 9, further comprising controlling a number of iterations in solving the optimization problem to control an error in the solution.
Embodiment 11 A system, comprising hardware and/or software, operable to perform any of the operations, methods, or processes, or any portion of any of these, disclosed herein.
Embodiment 12 A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, client, service, or the like may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

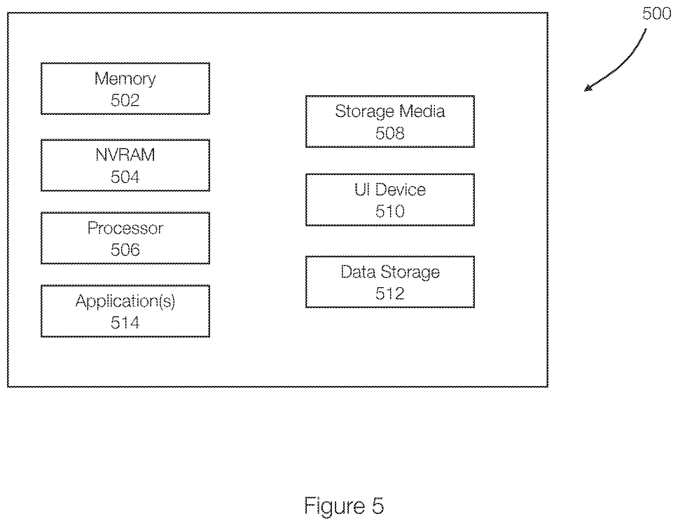

With reference briefly now to FIG. 5, any one or more of the entities disclosed, or implied, by the Figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
obtaining compressed data and a linear mapping, wherein the compressed data is generated from original data;
creating an optimization problem using the compressed data and the linear mapping;
solving the optimization problem to generate a solution, wherein the solution corresponds to the original data; and
performing an operation using the solution.

2. The method of claim 1, wherein the original data comprises telemetry data.

3. The method of claim 1, wherein the linear mapping comprises a Gaussian matrix and wherein coefficients are sampled from a Gaussian distribution.

4. The method of claim 1, wherein the solution is an estimated solution.

5. The method of claim 4, further comprising selecting parameters for minimization and for stopping criteria.

6. The method of claim 5, further comprising controlling an error of the solution.

7. The method of claim 1, further comprising solving the optimization problem using an alternating direction method of multipliers.

8. The method of claim 1, further comprising performing at least one of a data science operation, a customer service operations, or a root cause analysis operation.

9. The method of claim 1, wherein the original data is not exactly gradient sparse.

10. The method of claim 1, further comprising controlling a number of iterations in solving the optimization problem to control an error in the solution.

11. A non-transitory storage medium having stored therein instructions that are executable by one or more hardware processors to perform operations comprising:
obtaining a compressed data and a linear mapping, wherein the compressed data is generated from original data;
creating an optimization problem using the compressed data and the linear mapping;
solving the optimization problem to generate a solution, wherein the solution corresponds to the original data; and
performing an operation using the solution.

12. The non-transitory storage medium of claim 11, wherein the original data comprises telemetry data.

13. The non-transitory storage medium of claim 11, wherein the linear mapping comprises a Gaussian matrix and wherein coefficients are sampled from a Gaussian distribution.

14. The non-transitory storage medium of claim 11, wherein the solution is an estimated solution.

15. The non-transitory storage medium of claim 14, further comprising selecting parameters for minimization and for stopping criteria.

16. The non-transitory storage medium of claim 15, further comprising controlling an error of the solution.

17. The non-transitory storage medium of claim 11, further comprising solving the optimization problem using an alternating direction method of multipliers.

18. The method of claim 11, further comprising performing at least one of a data science operation, a customer service operations, or a root cause analysis operation.

19. The non-transitory storage medium of claim 11, wherein the original data is not exactly gradient sparse.

20. The non-transitory storage medium of claim 11, further comprising controlling a number of iterations in solving the optimization problem to control an error in the solution.
